(19) United States
(12) Patent Application Publication
(10) Pub. No.: US 2025/0102893 A1
(43) Pub. Date: Mar. 27, 2025

(54) LIGHT SOURCE APPARATUS AND PROJECTION SYSTEM

(71) Applicant: HISENSE LASER DISPLAY CO., LTD., Shandong (CN)

(72) Inventor: Haodong WANG, Shandong (CN)

(21) Appl. No.: 18/970,553

(22) Filed: Dec. 5, 2024

Related U.S. Application Data
(63) Continuation of application No. PCT/CN2022/126808, filed on Oct. 21, 2022.

(30) Foreign Application Priority Data
Jun. 23, 2022 (CN) 202210725162.6
Jun. 23, 2022 (CN) 202210726237.2
Jun. 23, 2022 (CN) 202221613791.1

(51) Int. Cl. G03B 21/20; G02B 27/10

(52) U.S. Cl. CPC G03B 21/2033; G02B 27/102; G03B 21/2013; G03B 21/2066; G03B 21/208

(57) ABSTRACT

Disclosed are a light source apparatus and a projection system. The light source apparatus includes: a LED source assembly including a first LED source, a second LED source, a third LED source and a fourth LED source, a laser source assembly configured to emit a laser beam, a first beam combination component and a second beam combination component. The first LED source and the laser source assembly are arranged with their light emitting directions being perpendicular. The second beam combination component is configured to combine the beam emitted from the first LED source and the laser beam. The first beam combination component is configured to reflect one of the two incident beams whose light incident directions are perpendicular and to transmit the other of the two incident beams whose light incident directions are perpendicular.

### CROSS-REFERENCE TO RELATED APPLICATIONS

This application is a continuation application of International Application No. PCT/CN2022/126808 filed Oct. 21, 2022, which claims priority to Chinese Patent Application No. 202210725162.6, filed with the China National Intellectual Property Administration on Jun. 23, 2022 and entitled “Light Source Apparatus and Projection System”, and Chinese Patent Application No. 202210726237.2, filed with the China National Intellectual Property Administration on Jun. 23, 2022 and entitled “Light Source Apparatus and Projection System”, both of which are hereby incorporated by reference in their entireties.

### TECHNICAL FIELD

The disclosure relates to the technical field of projection display, and in particular to a light source apparatus and projection system.

### BACKGROUND

Projection display is a technology that controls a light source using planar image information, utilizes an optical system and projection space to enlarge the image, and displays it on a projection screen. With the development of projection display technology, it has gradually been applied in fields such as business activities, conferences and exhibitions, scientific education, military command, traffic management, centralized monitoring, and advertising entertainment. Due to the advantages, such as large display size and clear display, the projection display can also be suitable for the requirements of large-screen displays.

Light Emitting Diodes (LEDs) have advantages such as fast response, low power consumption, and long lifespan. Applying LEDs to projection systems can alter the complex light path structure of traditional light sources. Additionally, the small size of LED sources is beneficial for designing compact and lightweight projection systems.

However, due to the loss of light energy during the projection process, current LED source projection systems still face issues of low brightness, and it is difficult to further enhance color performance and expand the color gamut.

### SUMMARY

According to a first aspect of the disclosure, a light source apparatus is provided. The light source apparatus includes: an LED source assembly, a laser source assembly, and a first beam combination assembly. The first beam combination assembly combines a three-color beam emitted from the LED source assembly with a laser beam emitted from the laser source assembly. By adding a laser source assembly to the light source apparatus and combining the monochromatic beam emitted from the laser source assembly with the three-color beam emitted from the LED source assembly, the light source apparatus can be improved without altering the structure of the LED source assembly, thereby increasing the brightness of the light emitted from the light source apparatus. The laser source has a wide color gamut, and color performance and color gamut can be effectively enhanced by adjusting the ratio of the laser source to the LED source. The laser source is smaller in size and consumes less energy than the corresponding LED source, thus combining the LED source assembly with the laser source assembly does not excessively increase the size and energy consumption of the light source apparatus.

According to a second aspect of the disclosure, a light source apparatus is provided. The light source apparatus includes: a first LED source, a second LED source, a third LED source, and at least one laser source. The light source apparatus is equipped with two beam combination assemblies. The first beam combination assembly is located at an intersection of a beam emitted from the first LED source and a laser beam emitted from the laser source, and is configured to combine the beam emitted from the first LED source with the laser beam emitted from the laser source. The second beam combination assembly is located at an intersection of a beam emitted from the second LED source, a beam emitted from the third LED source, and a beam emitted from the first beam combination assembly, and is configured to combine the beam emitted from the first beam combination assembly with the beams emitted from the second LED source and the third LED source. Adding a laser source to the three-color LED source system increases the brightness of the light emitted from the light source apparatus. The laser source has a wide color gamut, thus color performance and color gamut can be effectively enhanced by adjusting the ratio of the laser source to the LED source. The laser source is smaller in size and consumes less energy than the corresponding LED source, thus adding a laser source to the existing LED source system does not excessively increase the size and energy consumption of the light source apparatus.

According to a third aspect of the disclosure, a projection system is provided. The projection system includes any of the above light source apparatuses, an illumination path component, a light valve modulation component, and a projection lens. The illumination path component is located at a light emitting side of the light source apparatus, the light valve modulation component is located at a light emitting side of the illumination path component, and the projection lens is located on a reflection path of the light valve modulation component. By controlling a color ratio of the laser source and the LED source, the projection system can provide desired image quality with enhanced color, color gamut, and brightness.

### BRIEF DESCRIPTION OF FIGURES

To more clearly illustrate the technical solutions of the disclosure, the following provides a brief description to the figures needed in the embodiments of the disclosure. It is obvious that the figures described below are only some embodiments of the disclosure, and those skilled in the art can obtain other figures without creative effort based on these figures.

FIG. 1 is a schematic structural diagram of a light source apparatus in related art.

FIG. 2 is a first schematic structural diagram of a light source apparatus according to embodiments of the disclosure.

FIG. 3 is a schematic structural diagram of an LED source assembly according to embodiments of the disclosure.

FIG. 4 is a second schematic structural diagram of a light source apparatus according to embodiments of the disclosure.

FIG. 5 is a third schematic structural diagram of a light source apparatus according to embodiments of the disclosure.

FIG. 6 is a fourth schematic structural diagram of a light source apparatus according to embodiments of the disclosure.

FIG. 7 is a fifth schematic structural diagram of a light source apparatus according to embodiments of the disclosure.

FIG. 8 is a sixth schematic structural diagram of a light source apparatus according to embodiments of the disclosure.

FIG. 9 is a seventh schematic structural diagram of a light source apparatus according to embodiments of the disclosure.

FIG. 10 is an eighth schematic structural diagram of a light source apparatus according to embodiments of the disclosure.

FIG. 11 is a ninth schematic structural diagram of a light source apparatus according to embodiments of the disclosure.

FIG. 12 is a tenth schematic structural diagram of a light source apparatus according to embodiments of the disclosure.

FIG. 13 is an eleventh schematic structural diagram of a light source apparatus according to embodiments of the disclosure.

FIG. 14 is a twelfth schematic structural diagram of a light source apparatus according to embodiments of the disclosure.

FIG. 15 is a thirteenth schematic structural diagram of a light source apparatus according to embodiments of the disclosure.

FIG. 16 is a fourteenth schematic structural diagram of a light source apparatus according to embodiments of the disclosure.

FIG. 17 is a fifteenth schematic structural diagram of a light source apparatus according to embodiments of the disclosure.

FIG. 18 is a sixteenth schematic structural diagram of a light source apparatus according to embodiments of the disclosure.

FIG. 19 is a seventeenth schematic structural diagram of a light source apparatus according to embodiments of the disclosure.

FIG. 20 is a first schematic structural diagram of a projection system according to embodiments of the disclosure.

FIG. 21 is a second schematic structural diagram of a projection system according to embodiments of the disclosure.

Here:
S1—LED source assembly; S2—laser source assembly; S3—first beam combination assembly; 2—second beam combination assembly; 11—first LED source; 12—second LED source; 13—third LED source; 14—fourth LED source; 121—blue LED chip; 122—green fluorescent powder; L—laser source; 21—first beam combination mirror; 22—second beam combination mirror; 23—mirror; 24—third beam combination mirror; 25—fourth beam combination mirror; 31—first collimating lens group; 32—second collimating lens group; 33—third collimating lens group; 34—fourth collimating lens group; 35—converging lens group; f—reflection portion; h—transmission portion; f′—reflection region; 4—beam-reducing lens group; 5—beam homogenization component; 51—first beam homogenization component; 52—second beam homogenization component; 6—fifth collimating lens group; 100—light source apparatus; 200—illumination path component; 300—light valve modulation component; 400—projection lens.

### DETAILED DESCRIPTION

To make the objectives, features, and advantages of the disclosure clearer and more understandable, the disclosure will be described in conjunction with the accompanying drawings and embodiments. However, the exemplary embodiments can be implemented in various forms and should not be understood as limited to the embodiments described here. On the contrary, these embodiments are provided to make the disclosure more comprehensive and complete, and to fully convey the concepts of the exemplary embodiments to those skilled in the art. In the drawings, the same reference numerals indicate the same or similar structures, and the repetitive description will be omitted. The terms used to describe positions and directions in the disclosure are described using the drawings as examples, but changes can be made as needed, and such changes are included within the protection scope of the disclosure. The drawings of the disclosure are only used to illustrate relative positional relationships and do not represent actual proportions.

Projection display is a technology that controls a light source using planar image information, utilizing an optical system and projection space to enlarge the image and display it on a projection screen.

The projection light source is a critical component of the projection system, determining the display brightness and color gamut. Light Emitting Diodes (LEDs) have advantages such as fast response, low power consumption, and long lifespan. Using LEDs as the light source in a projection system can alter the complex light path structure of traditional light sources. Moreover, the small size of the LED source is beneficial for designing compact and lightweight projection systems.

To achieve full-color display, it is typically necessary to include light sources that can emit the beams of three primary colors in the light source apparatus. In a light source apparatus using LEDs as the light source, a first LED source configured to emit a red beam, a second LED source configured to emit a green beam, and a third LED source configured to emit a blue beam can be arranged.

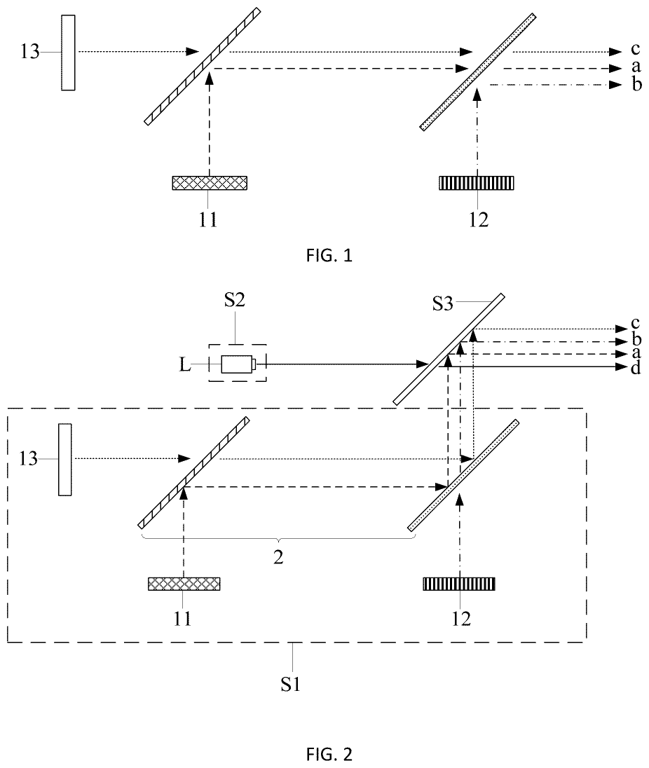

FIG. 1 is a schematic structural diagram of a light source apparatus in related art.

As shown in FIG. 1, the red beam a emitted from the first LED source 11, the green beam b emitted from the second LED source 12, and the blue beam c emitted from the third LED source 13 are combined and then emitted. This allows the projection light source to emit a beam of three primary colors.

However, due to the loss of light energy during the projection process, current projection systems using LED sources still have the problem of low brightness, and because of the limited color gamut of LEDs, image color or the color gamut cannot be enhanced.

Therefore, in embodiments of the disclosure, a laser source is added to the LED source architecture to increase the brightness of the light source apparatus, and to facilitate further enhancement of the color gamut and optimizing the color performance of the projection system.

In some embodiments, a laser source can be added without changing the structure of the three-color LED source, thereby improving the brightness of the light source apparatus and expanding the color gamut of the light source apparatus.

In some embodiments, beam combination can be made first for the LED source and laser source that emit beams of same color, and then the beams of three primary colors can be combined, thus improving the brightness and expanding the color gamut of the light source apparatus.

The specific structures of the different types of light source apparatuses mentioned above will be described below.

It should be noted that, one or more beam combination assemblies are involved in embodiments of the disclosure. One beam combination assembly can include at least one beam combination component for beam combination. In some embodiments, the beam combination can be, for example, a beam combination mirror.

FIG. 2 is a first schematic structural diagram of a light source apparatus according to the embodiments of the disclosure.

In some embodiments, as shown in FIG. 2, the light source apparatus according to embodiments of the disclosure includes: an LED source assembly S1, a laser source assembly S2, and a first beam combination assembly S3.

The LED source assembly S1 at least includes: a first LED source 11, a second LED source 12, and a third LED source 13. The first LED source 11 can emit a beam a of a first wavelength band, the second LED source 12 can emit a beam b of a second wavelength band, and the third LED source 13 emits a beam c of a third wavelength band.

In embodiments of the disclosure, the beam a of the first wavelength band can be red light, the beam b of the second wavelength band can be green light, and the beam c of the third wavelength band can be blue light, which is not limited here.

The laser source assembly S2 includes at least one laser source L, which can emit a laser beam d of a fourth wavelength band. The laser beam has a narrower half-peak width and higher energy at the peak wavelength, while the LED source emits light of less energy and covering a broader wavelength band compared to the laser source. In embodiments of the disclosure, the first LED source 11 and the laser source L can emit the light of the same color, and the first wavelength band of the beam emitted from the first LED source 11 covers the fourth wavelength band of the laser beam emitted from the laser source L. The laser beam d of the fourth wavelength band emitted from the laser source L can be red light.

The first beam combination assembly S3 is located at an intersection of the beam emitted from the LED source assembly S1 and the laser beam emitted from the laser source assembly S2. The first beam combination assembly S3 is configured to reflect the beam emitted from the LED source assembly S1 and transmit the laser beam emitted from the laser source assembly S2.

The light source apparatus according to embodiments of the disclosure includes two types of light source assemblies, which are the LED source assembly and the laser source assembly. The brightness of the light from the laser source assembly is greater than the brightness of the light from the LED source assembly. By adding a laser source assembly to the light source apparatus and combining the monochromatic beam emitted from the laser source assembly with the three-color beam emitted from the LED source assembly, the light source apparatus can be improved without altering the structure of the LED source assembly, increasing the brightness of the light emitted from the light source apparatus. The laser source has a larger color gamut, and the color performance can be effectively enhanced and the color gamut can be increased by adding a laser source assembly to the light source apparatus and adjusting the ratio of the laser source and the LED source. The size and energy consumption of common laser sources are currently smaller than those of the corresponding LED sources, thus combining the LED source assembly with the laser source assembly will not excessively increase the size and energy consumption of the light source apparatus.

Specifically, as shown in FIG. 2, the LED source assembly is equipped with a second beam combination assembly 2. The second beam combination assembly 2 is located at an intersection of the beams emitted from the respective LED sources, and can combine the beams of different colors emitted from the respective LED sources into a white beam, which is then emitted to the first beam combination assembly S3.

In a specific implementation, the first LED source 11 uses a red LED, the second LED source 12 uses a green LED, and the third LED source 13 uses a blue LED. The laser source L uses a red laser chip or a red laser, which is not limited.

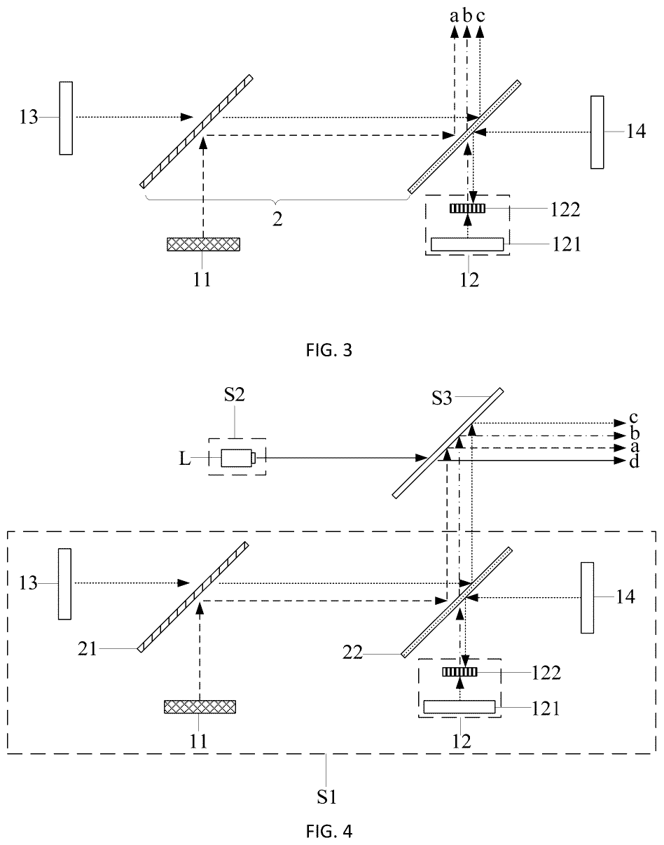

FIG. 3 is a schematic structural diagram of the LED source assembly according to embodiments of the disclosure.

The second LED source 12 uses a green LED, which includes a blue LED chip 121 and green fluorescent powder 122. The green beam can be emitted from exciting the green fluorescent powder 122 using the blue LED chip 121. However, since the green LED light typically has lower brightness, to enhance the brightness of the green beam, an additional blue light source can be arranged and frequency of the stimulated emission from the green fluorescent powder 122 can be increased, thereby increasing the intensity of the green beam.

In some embodiments, as shown in FIG. 3, the LED source assembly further includes a fourth LED source 14. The fourth LED source 14 can emit the beam c of the third wavelength band, and is configured to irradiate and excite the second LED source 12 to emit the beam b of the second wavelength band.

As shown in FIG. 3, the fourth LED source 14 can direct beam c of the third wavelength band towards the second LED source 12 via the second beam combination assembly 2, thereby exciting the green fluorescent powder 122 in the second LED source 12 to increase the emission of the beam b of the second wavelength band.

In embodiments of the disclosure, the beam b of the second wavelength band can be green light, while the beam c of the third wavelength band can be blue light. The second LED source 12 can be a green LED, and the fourth LED source 14 can be a blue LED. The blue light emitted from the blue LED excites the green fluorescent powder 122 in the second LED source 12, thereby emitting additional green beam and increasing the frequency of the stimulated emission from the green fluorescent powder 122, which in turn increases the brightness of the green beam in the light source apparatus.

FIG. 4 is a second schematic structural diagram of a light source apparatus according to embodiments of the disclosure.

As shown in FIG. 4, the second beam combination assembly includes two beam combination components, such as a first beam combination mirror 21 and a second beam combination mirror 22. The first LED source 11 and the second LED source 12 are arranged in line and the light emitting directions of the first LED source 11 and the second LED source 12 are parallel, while the first LED source 11 and the third LED source 13 are arranged with their light incident directions on the first beam combination mirror 21 being perpendicular, and the second LED source 12 and the fourth LED source 14 are arranged with their light incident directions on the second beam combination mirror 22 being perpendicular.

The first beam combination mirror 21 is located at the intersection of the beam emitted from the first LED source 11 and the beam emitted from the third LED source 13. The first beam combination mirror 21 is configured to transmit the beam c of the third wavelength band and reflect the beam a of the first wavelength band.

The second beam combination mirror 22 is located at the intersection of the beam emitted from the first beam combination mirror 21 and the beam emitted from the second LED source 12, as well as at the intersection of the beam emitted from the second LED source 12 and the beam emitted from the fourth LED source 14. The second beam combination mirror 22 is configured to transmit the beam b of the second wavelength band and reflect the beam a of the first wavelength band and the beam c of the third wavelength band.

In embodiments of the disclosure, the beam a of the first wavelength band is red light, the beam b of the second wavelength band is green light, and the beam c of the third wavelength band is blue light. Both the first beam combination mirror 21 and the second beam combination mirror 22 can be dichroic mirrors, which are formed by coating the surface of a transparent flat plate based on the principle of thin-film interference, to enhance transmission or reflection of beams of different wavelength bands as needed.

Specifically, as shown in FIG. 4, the first beam combination mirror 21 is configured to transmit blue light and reflect red light. The blue beam (beam c of the third wavelength band) emitted from the third LED source 13 is incident on the first beam combination mirror 21, and then transmitted by the first beam combination mirror 21 in the direction toward the second beam combination mirror 22. The red beam (beam a of the first wavelength band) emitted from the first LED source 11 is incident on the first beam combination mirror 21, and reflected by the first beam combination mirror 21 in the direction toward the second beam combination mirror 22, thereby combining the blue beam (beam c of the third wavelength band) and the red beam (beam a of the first wavelength band).

The second beam combination mirror 22 is configured to transmit green light and reflect blue and red light. The blue beam (beam c of the third wavelength band) and red beam (beam a of the first wavelength band) from the first beam combination mirror 21 are incident on the second beam combination mirror 22 and are reflected by the second beam combination mirror 22 towards the first beam combination assembly S3. The blue beam (beam c of the third wavelength band) emitted from the fourth LED source 14 is incident on the second beam combination mirror 22 and is reflected by the second beam combination mirror 22 towards the second LED source 12. The green beam (beam b of the second wavelength band) emitted based on exciting the green fluorescent powder 122 in the second LED source 12 by the blue beam (beam c of the third wavelength band) emitted from the fourth LED source 14, and the green beam (beam b of the second wavelength band) emitted from the second LED source 12 are incident on the second beam combination mirror 22 and is transmitted by the second beam combination mirror 22 towards the first beam combination assembly S3, thereby combining the red beam (beam a of the first wavelength band), green beam (beam b of the second wavelength band), and blue beam (beam c of the third wavelength band) into a white beam, which is then emitted towards the first beam combination assembly S3.

It should be noted that in embodiments of the disclosure, the light emitting directions of the respective LED sources can be either parallel or perpendicular. Therefore, each beam combination mirror in the second beam combination assembly needs to be set at a 45° angle with respect to the incident beam. When the LED beam is incident on any of the beam combination mirrors in the beam combination assembly, it should be incident at a center of the beam combination mirror. This ensures that centers of light spots on the beam combination mirror coincide, making the energy distribution of a light spot of the combined beam more uniform.

FIG. 5 is a third schematic structural diagram of a light source apparatus according to embodiments of the disclosure.

The laser source assembly S2 includes at least one laser source L. To enhance laser intensity, as shown in FIG. 5, the laser source assembly S2 can include two or more laser sources L. These laser sources L can be laser chips or lasers. In embodiments of the disclosure, the laser source assembly S2 can include two laser sources L arranged in parallel, and these laser sources can be red lasers.

In specific implementations, a converging lens group 35 can be set on a light emitting side of the respective laser sources L to converge the laser beams emitted from the respective laser sources L, thereby combining the laser beams emitted from the respective laser sources L into one laser spot.

In embodiments of the disclosure, the converging lens group 35 includes at least one lens. If only one lens is used, it can be a convex lens, which is not limited here.

The principle of beam combination for the LED source assembly S1 and the laser source assembly S2 will be specifically described below.

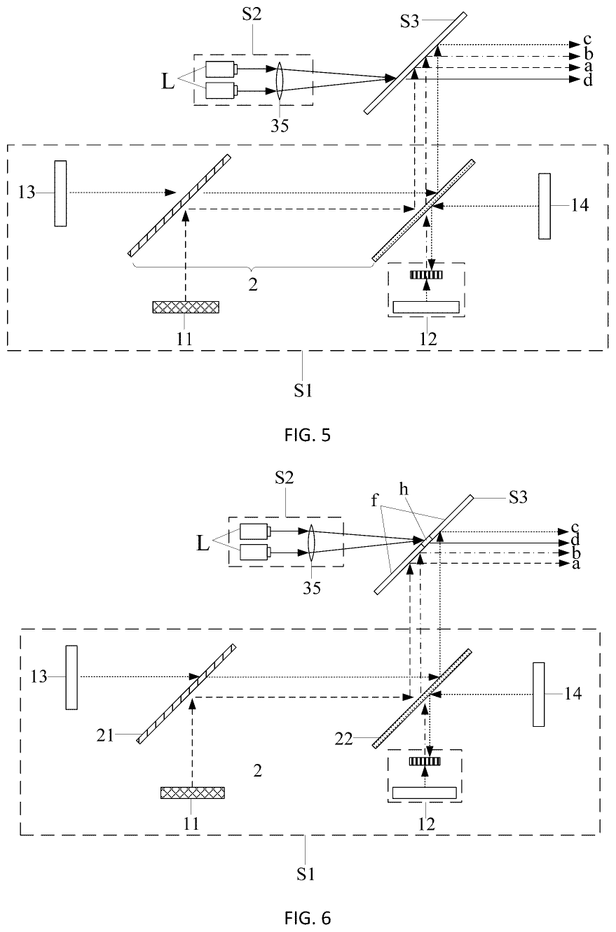

FIG. 6 is a fourth schematic structural diagram of a light source apparatus according to embodiments of the disclosure.

As shown in FIG. 6, the first beam combination assembly S3 can include one beam combination component, which includes a reflection portion f and a transmission portion h. The reflection portion f is configured to reflect the beam emitted from the LED source assembly S1 in a set direction, while the transmission portion h is configured to transmit the beam emitted from the laser source assembly S2 in the set direction. Taking FIG. 6 as an example, the set direction is horizontally to the right. The first beam combination assembly S3 is configured to combine the beam emitted from the LED source assembly S1 and the laser beam emitted from the laser source assembly S2 in the same direction.

Specifically, a mirror can be provided as the reflection portion f of the first beam combination assembly S3, and a through-hole can be provided as the transmission portion h. During manufacturing, a hole can be made in the mirror to form a mirror structure with a through-hole.

The mirror (reflection portion f) is configured to reflect the beam a of the first wavelength band, the beam b of the second wavelength band, and the beam c of the third wavelength band, while the through-hole (transmission portion h) is configured to transmit the laser beam d.

In embodiments of the disclosure, a mirror with a through-hole (transmission portion h), rather than a dichroic mirror, is used as the first beam combination assembly S3. This is because the first beam combination assembly S3 needs to reflect the beam a of the first wavelength band, the beam b of the second wavelength band, and the beam c of the third wavelength band, while also transmitting the laser beam d of the fourth wavelength band. A dichroic mirror cannot simultaneously reflect and transmit the beam of the same wavelength band. Therefore, a mirror with a through-hole is used, which provides a high reflectance for the three-color beam emitted from the LED source assembly S1 while allowing the highly collimated laser beam with a small spot size to pass through the hole, thereby achieving the combination of the three-color LED beam with the laser beam.

In the embodiment of the disclosure, as shown in FIG. 6, the through-hole (transmission portion h) can be positioned at a center of the mirror (reflection portion f). A line connecting a center point of the mirror (reflection portion f) and a center point of the second beam combination mirror 22 is parallel to the light emitting direction of the second LED source 12. The laser spot, emitted from the laser source assembly S2, on the first beam combination assembly S3 is symmetrical about the center point of the mirror (reflection portion f), and the light spot, emitted from the LED source assembly S1, on the first beam combination assembly S3 is symmetrical about the center point of the mirror (reflection portion f). This allows the laser spot to be at the center of the light spot of the combined beam, making the energy distribution of the light spot of the combined beam more uniform.

Since the through-hole (transmission portion h) can transmit part of the beam emitted from the LED source assembly S1, causing light loss, in the embodiments of the disclosure, the size of the through-hole (transmission portion h) is kept as small as possible, only large enough to transmit the laser spot. For example, an area of the through-hole (transmission portion h) can be set to be less than or equal to one-tenth of an area of the light spot emitted from the LED source assembly S1, thereby controlling the energy loss of the beam emitted from the LED source assembly and transmitted through the through-hole (transmission portion h) to be less than 10%. Since the laser beam has greater energy compared to the LED beam, light loss can be compensated.

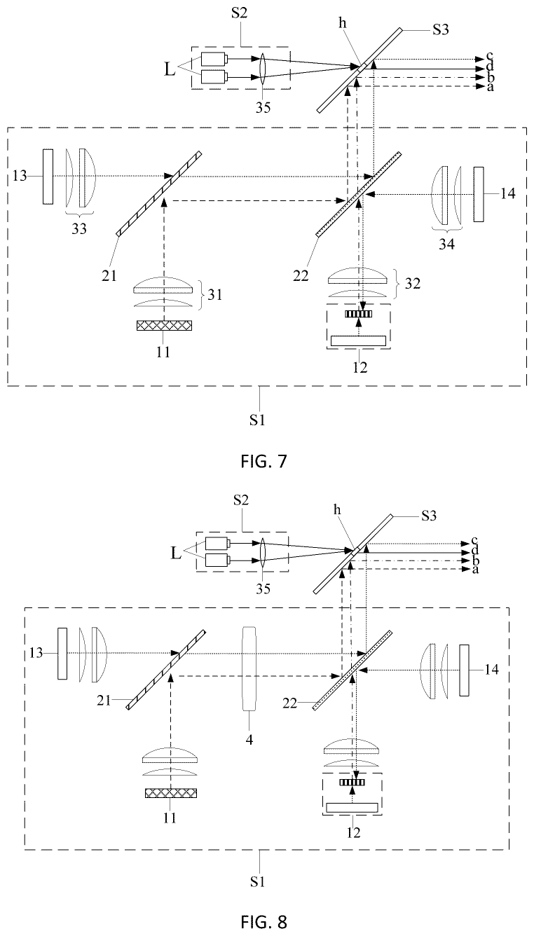

FIG. 7 is a fifth schematic structural diagram of a light source apparatus according to embodiments of the disclosure.

As shown in FIG. 7, the LED source assembly S1 further includes a first collimating lens group 31, a second collimating lens group 32, a third collimating lens group 33, and a fourth collimating lens group 34. The first collimating lens group 31 is positioned at a light emitting side of the first LED source 11, the second collimating lens group 32 is positioned at a light emitting side of the second LED source 12, the third collimating lens group 33 is positioned at a light emitting side of the third LED source 13, and the fourth collimating lens group 34 is positioned at a light emitting side of the fourth LED source 14.

Since the beam emitted from LED sources follows a Lambertian distribution and has a large divergence angle, collimating lens groups are arranged at the light emitting sides of the respective LED sources to collimate the beam before further propagation.

Each of the collimating lens groups includes at least one lens. For example, as shown in FIG. 7, the collimating lens group may include two lenses, which is not limited here. The structure of the first collimating lens group 31, second collimating lens group 32, third collimating lens group 33, and fourth collimating lens group 34 may be the same or different, which is not limited here.

FIG. 8 is a sixth schematic structural diagram of a light source apparatus according to embodiments of the disclosure.

As shown in FIG. 8, the LED source assembly S1 further includes a beam-reducing lens group 4. The beam-reducing lens group 4 is positioned between the first beam combination mirror 21 and the second beam combination mirror 22.

The optical paths of the beam emitted from the various LED sources before combining are not the same, and the beam emitted from the LED sources inherently has a certain divergence angle. The optical paths of the beams from the first LED source 11 and the third LED source 13 before reaching the second beam combination mirror 22 are longer than that of the second LED source 12, resulting in a larger spot size due to divergence over the longer optical path. The combined beam from the first LED source 11 and the third LED source 13 needs to pass through the beam-reducing lens group 4 before reaching the second beam combination mirror 22, so that the light spot of the combined beam from the first LED source 11 and the third LED source 13 is as close in size as possible to the light spot of the second LED source 12.

In the embodiments of the disclosure, the beam-reducing lens group 4 includes at least one lens. If only one lens is used, it can be a convex lens, which is not limited here.

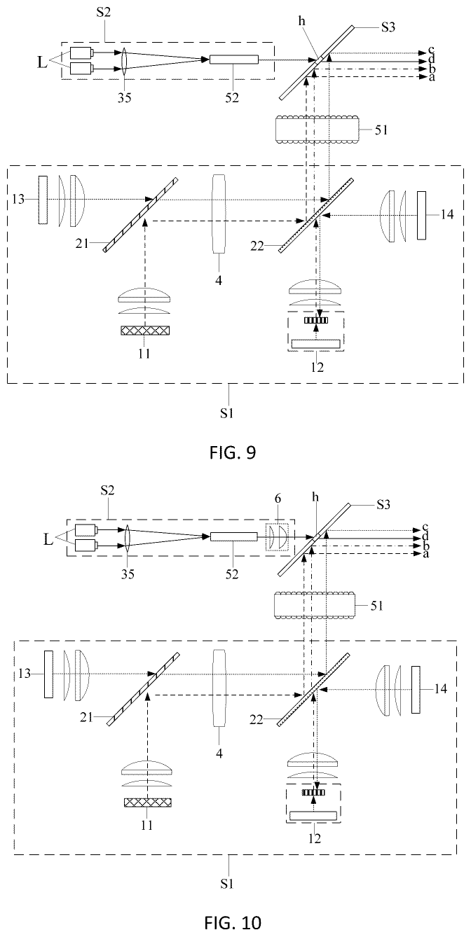

FIG. 9 is a seventh schematic structural diagram of a light source apparatus according to embodiments of the disclosure.

As shown in FIG. 9, the LED source assembly S1 further includes a first beam homogenization component 51, which is located at the light emitting side of the second beam combination mirror 22. Correspondingly, the laser source assembly S2 also includes a second beam homogenization component 52, which is located at the light emitting side of the converging lens group 35.

The first beam homogenization component 51 is arranged at the light emitting side of the second beam combination mirror 22 and the second beam homogenization component 52 is arranged at the light emitting side of the converging lens group 35, that is, separate beam homogenization components can be arranged for the light paths of the LED source assembly S1 and the laser source assembly S2 respectively without modifying the structure of the LED source assembly S1. The beams emitted from both types of light source assemblies are uniform beams.

In specific implementations, as shown in FIG. 9, the first beam homogenization component 51 can be a fly-eye lens group, which includes a first fly-eye lens and a second fly-eye lens arranged opposite to each other. The surfaces of both the first fly-eye lens and the second fly-eye lens include an array of small lens units. The combined beam after the second beam combination mirror 22 typically include parallel rays, which pass through the first fly-eye lens, and then are focused on the centers of the small lens units of the second fly-eye lens. The second fly-eye lens then superposes the imaging rays from the first fly-eye lens onto an illumination surface. This effectively improves the uniformity and brightness of the illumination beam.

As shown in FIG. 9, the second beam homogenization component 52 can be elements such as a light-pipe or light rod, which is not limited here.

Additionally, the first beam homogenization component 51 and the second beam homogenization component 52 can be other optical elements with homogenizing functions to homogenize the beam emitted from each light source assembly, making the energy distribution of the light spots more uniform.

FIG. 10 is an eighth schematic structural diagram of a light source apparatus according to embodiments of the disclosure.

As shown in FIG. 10, the laser source assembly S2 further includes a fifth collimating lens group 6, which is positioned at the light emitting side of the second beam homogenization component 52.

The laser beam emitted from the laser source assembly needs to pass through the through-hole and be combined with the beam emitted from the LED source assembly. To ensure that the final laser spot from the laser source assembly is small enough, a fifth collimating lens group 6 is set at the light emitting side of the second beam homogenization component 52 to further collimate the homogenized laser beam. This ensures that as much of the final emitted laser beam as possible can pass through the through-hole (transmission portion h) and be utilized.

The fifth collimating lens group 6 includes at least one lens. For example, as shown in FIG. 10, the fifth collimating lens group 6 may include two lenses, which is not limited here.

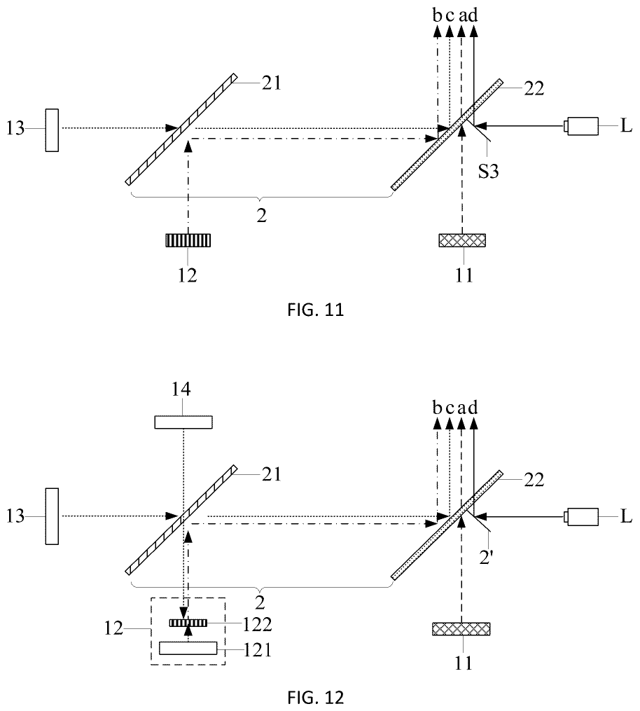

FIG. 11 is a ninth schematic structural diagram of a light source apparatus according to embodiments of the disclosure.

In some embodiments, as shown in FIG. 11, the light source apparatus according to embodiments of the disclosure includes a first LED source 11, a second LED source 12, and a third LED source 13. The first LED source 11 can emit a beam a of the first wavelength band, the second LED source 12 can emit a beam b of the second wavelength band, and the third LED source 13 can emit a beam c of the third wavelength band. In the embodiments of the disclosure, the beam a of the first wavelength band can be red light, the beam b of the second wavelength band can be green light, and the beam c of the third wavelength band can be blue light, which is not limited here.

The light source apparatus further includes at least one laser source L, which can emit a laser beam d of a fourth wavelength band. The laser beam has a narrow half-peak width and high energy at the peak wavelength, while the LED source emits light with lower energy and covering a broader wavelength band compared to the laser source. In the embodiments of the disclosure, the first LED source 11 and the laser source L emit light of the same color, and the first wavelength band of the beam a emitted from the first LED source 11 covers the fourth wavelength band of the laser beam d emitted from the laser source L. The laser beam d of the fourth wavelength band emitted by the laser source L can be red light.

As shown in FIG. 11, the light source apparatus further includes a first beam combination assembly S3 and a second beam combination assembly 2.

The first beam combination assembly S3 is located at an intersection of the beam emitted from the first LED source 11 and the laser beam emitted from the laser source. The first beam combination assembly S3 is configured to combine the beam a of the first wavelength band emitted from the first LED source 11 and the laser beam d of the fourth wavelength band emitted from the laser source L.

The second beam combination assembly 2 is positioned at an intersection of the beam emitted from the first beam combination assembly S3, the beam emitted from the second LED source 12, and the beam emitted from the third LED source 13. The second beam combination assembly 2 is configured to combine the beam a of the first wavelength band and the laser beam d of the fourth wavelength band emitted from the first beam combination assembly S3 with the beam b of the second wavelength band emitted from the second LED source 12 and the beam c of the third wavelength band emitted from the third LED source 13.

The brightness of the laser source is higher than that of the LED source. By adding a laser source to the three-color LED source system, the laser beam emitted from the laser source and the beam of the same color, as the laser beam, emitted from the LED source are combined, and then combined with the beams from other color LEDs, increasing the output brightness of the light source apparatus. The laser source has a larger color gamut, and color performance can be enhanced and the color gamut can be improved by adjusting the ratio of the added laser source to the LED source in the light source apparatus. Furthermore, the size and power consumption of common laser sources are smaller than the corresponding LED sources, so adding a laser source to the existing LED source system does not significantly increase the size or power consumption of the light source apparatus.

In a specific implementation, the first LED source 11 uses a red LED, the second LED source 12 uses a green LED, and the third LED source 13 uses a blue LED. The laser source L uses a red laser chip or red laser, which is not limited here.

FIG. 12 shows a tenth schematic structural diagram of a light source apparatus according to embodiments of the disclosure.

The second LED source 12 uses a green LED, which internally includes a blue LED chip 121 and green fluorescent powder 122. The blue LED chip 121 excites the green fluorescent powder 122 to emit green light. However, the brightness of the green LED light is relatively low. To increase the brightness of the green light, an additional blue light source can be used to irradiate and excite the green fluorescent powder 122, increasing the frequency of stimulated emission from the green fluorescent powder 122, thereby enhancing the intensity of the green beam.

As shown in FIG. 12, the light source apparatus further includes a fourth LED source 14. The fourth LED source 14 can emit the beam c of the third wavelength band and is configured to irradiate and excite the second LED source 12 to emit the beam b of the second wavelength band.

As shown in FIG. 12, the fourth LED source 14 can emit the beam of the third wavelength band through the second beam combination assembly 2 to the second LED source 12, thereby exciting the green fluorescent powder 122 in the second LED source 12 to emit more of the rays of the second wavelength band.

In embodiments of the disclosure, the beam b of the second wavelength band can be a green band, and the beam c of the third wavelength band can be a blue band. The second LED source 12 can be a green LED, and the fourth LED source 14 can be a blue LED. The blue light emitted from the blue LED excites the green fluorescent powder 122 in the second LED source 12, which can be excited to emit more green rays, thereby increasing the excitation frequency of the green fluorescent powder 122 and enhancing the brightness of the green beam in the light source apparatus.

As shown in FIG. 12, the second beam combination assembly 2 includes two beam combination components, such as a first beam combination mirror 21 and a second beam combination mirror 22.

The first LED source 11 and the second LED source 12 are arranged in line with their light emitting direction being parallel, the second LED source 12 and the third LED source 13 are arranged with their light incident directions on the first beam combination mirror 21 being perpendicular, and the second LED source 12 and the fourth LED source 14 are arranged oppositely with their light emitting directions being opposite. The first LED source 11 and the laser source L are arranged with their light emitting directions being perpendicular.

The first beam combination mirror 21 is located at an intersection of the beams emitted from the second LED source 12, the third LED source 13, and the fourth LED source 14. The first beam combination mirror 21 is configured to transmit the beam c of the third wavelength band and reflect the beam b of the second wavelength band. The second beam combination mirror 22 is located at an intersection of the beam emitted from the first beam combination mirror 21 and the beam emitted from the first beam combination assembly S3. The second beam combination mirror 22 is configured to transmit the beam a of the first wavelength band and reflect the beam b of the second wavelength band and the beam c of the third wavelength band. Since the first wavelength band covers the fourth wavelength band, the second beam combination mirror 22 can also transmit the laser beam d of the fourth wavelength band.

In embodiments of the disclosure, the beam of the first wavelength band is red light, the beam of the second wavelength band is green light, the beam c of the third wavelength band is blue light, and laser beam d of the fourth wavelength band is red light. Both the first beam combination mirror 21 and the second beam combination mirror 22 can be dichroic mirrors, which can be formed by coating the surface of a transparent plate based on the principle of thin-film interference, allowing for the selective transmission or reflection of the beams of different wavelengths.

Specifically, as shown in FIG. 12, the first beam combination mirror 21 is configured to transmit blue light and reflect green light. The blue beam (beam c of the third wavelength) emitted from the third LED source 13 is incident on the first beam combination mirror 21 and is transmitted toward the second beam combination mirror 22. The blue beam (beam c of the third wavelength band) emitted from the fourth LED source 14 is incident on the first beam combination mirror 21 and is transmitted toward the second LED source 12. The blue beam (beam c of the third wavelength band) emitted from the fourth LED source 14 excites the green fluorescent powder 122 in the second LED source 12 to emit green beam (beam b of the second wavelength band), and the green beam (beam b of the second wavelength band) emitted from the second LED source 12 is incident on the first beam combination mirror 21 and is reflected toward the second beam combination mirror 22. This combines the blue beam (beam c of the third wavelength band) and green beam (beam b of the second wavelength band).

The second beam combination mirror 22 is configured to transmit red light and reflect blue light and green light. The blue beam (beam c of the third wavelength band) and green beam (beam b of the second wavelength band) emitted from the first beam combination mirror 21 are incident on the second beam combination mirror 22 and are reflected toward a set direction. The red beam (beam a of the first wavelength band) emitted from the first LED source 11 and the red laser beam (beam d of the fourth wavelength band) emitted from the laser source L are combined and then incident on the second beam combination mirror 22 and transmitted toward the set direction. This combines the red beam (beam a of the first wavelength band), red laser beam (beam d of the fourth wavelength band), green beam (beam b of the second wavelength band), and blue beam (beam c of the third wavelength band) into a white beam, which is emitted in the specified direction.

It should be noted that in embodiments of the disclosure, the light emitting directions of the LED and laser sources can be either parallel or perpendicular. Therefore, any beam combination mirror in the second beam combination assembly needs to be positioned at a 45-degree angle relative to the incident beam. The LED source beam is incident on any beam combination mirror in the second beam combination assembly at the center, ensuring that the center of the light spot on the beam combination mirror coincide, thereby making the energy distribution of the combined light spot more uniform.

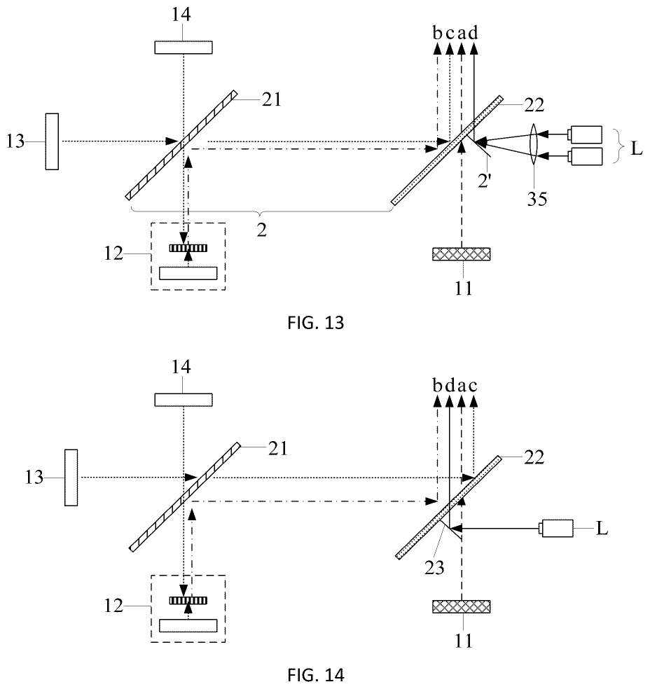

FIG. 13 is an eleventh schematic structural diagram of a light source apparatus according to embodiments of the disclosure.

At least one laser source L is provided in the light source apparatus. To increase laser intensity, as shown in FIG. 13, two or more laser sources L can be used in the light source apparatus. The laser sources L can be laser chips or lasers. In embodiments of the disclosure, the light source apparatus may include two parallel laser sources L, which can be red lasers.

In a specific implementation, a converging lens group 35 can be set at the light emitting side of the respective laser sources to converge the laser beams emitted from the respective laser sources, thereby combining the laser beams emitted from the respective laser sources into one laser spot.

In embodiments of the disclosure, the converging lens group 35 includes at least one lens. When only one lens is used, it can be a convex lens, which is not limited here.

The following describes the specific implementation method for combining the beams from the first LED source 11 and the laser source L.

FIG. 14 is a twelfth schematic structural diagram of a light source apparatus according to embodiments of the disclosure.

In some embodiments, as shown in FIG. 14, the first beam combination assembly can include one beam combination component, which can be a mirror 23. The mirror 23 is arranged on the second beam combination mirror 22 and is configured to reflect the laser beam emitted from the laser source L toward the second beam combination mirror 22.

The laser beam emitted from the laser source L is first incident on the mirror 23, which then reflects the laser beam toward the second beam combination mirror 22; while the beam emitted from the first LED source 11 is directly transmitted to the second beam combination mirror 22. As such, the beam from the first LED source 11 is combined with the laser beam from the laser source L.

In the embodiments of the disclosure, the mirror 23 can be positioned between the second beam combination mirror 22 and the first LED source 11. If a converging lens group is set at the light emitting side of the laser source, then the mirror 23 is placed at the light emitting side of the converging lens group.

It is noted that, as shown in FIG. 14, the laser source L and the first LED source 11 are arranged with their light emitting directions being perpendicular, and the second beam combination mirror 22 is inclined at a 45° angle relative to both the beams emitted from the first LED source 11 and the laser source L. The mirror 23 is inclined at a 45° angle relative to the beam emitted from the laser source L, thereby reflecting the incoming laser beam toward the second beam combination mirror 22.

The laser spot from the laser source L is symmetrical about the center of the mirror 23. A line connecting center points of the mirror 23 and the second beam combination mirror 22 is parallel to the light emitting direction of the first LED source 11. This arrangement ensures that the laser beam reflected by the mirror is directed toward the center of the second beam combination mirror 22, and the laser spot on the second beam combination mirror 22 is symmetrical about the center point of the second beam combination mirror 22. The light from the first LED source 11 is also incident at the center of the second beam combination mirror 22, making the light spot on the second beam combination mirror 22 symmetrical about the center point of the second beam combination mirror 22. As such, the laser spot is located at the center of the light spot of the combined beam, which helps achieve a more uniform energy distribution in the light spot of the combined beam.

Since the mirror 23 on the second beam combination mirror 22 blocks part of the beam emitted from the first LED source 11, the size of the mirror 23 in the embodiments of the disclosure is minimized and is large enough to fully receive the laser beam emitted from the laser source L. Because the laser beam has higher energy than the beam emitted from the LED, the blocked portion of beam emitted from the first LED source 11 can be compensated by the laser beam, which will not cause a large light loss.

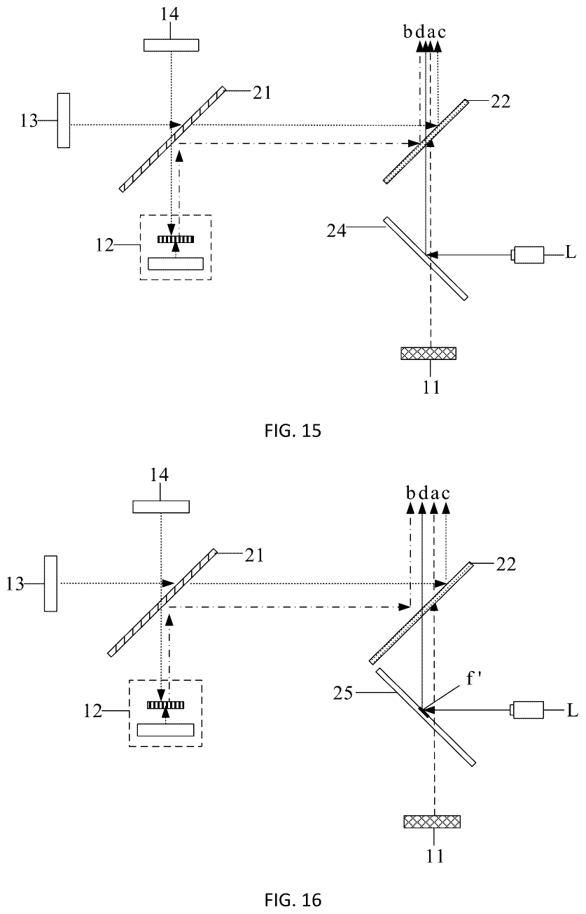

FIG. 15 is a thirteenth schematic structural diagram of a light source apparatus according to embodiments of the disclosure.

In some embodiments, as shown in FIG. 15, the first beam combination assembly can include one beam combination component, which can be a third beam combination mirror 24. The third beam combination mirror 24 is located between the first LED source 11 and the second beam combination mirror 22, and also at the intersection of the beam emitted from the first LED source 11 and the laser beam emitted from the laser source L. The third beam combination mirror 24 is configured to reflect the laser beam d of the fourth wavelength band and to transmit the beam of the first wavelength band excluding rays of the fourth wavelength band. Here, the fourth wavelength band is included in the first wavelength band.

The beam emitted from the first LED source 11 and laser beam from the laser source L have the same color, and the first wavelength band covers the fourth wavelength band. Therefore, the third beam combination mirror 24 can be a dichroic mirror, which reflects the beam of the fourth wavelength band and transmits the beam of the first wavelength band excluding rays of the fourth wavelength band.

The laser beam d of the fourth wavelength band emitted from the laser source L is reflected by the third beam combination mirror 24 toward the second beam combination mirror 22. For the beam a of the first wavelength band emitted from the first LED source 11 is incident on the third beam combination mirror 24, only rays of the fourth wavelength band are reflected by the third beam combination mirror 24, and the rest of the beam a of the first wavelength band passes through the third beam combination mirror 24, allowing the laser beam d of the fourth wavelength band from the laser source L to be combined with the rest of the beam of the first wavelength band from the first LED source 11.

It is noted that a line connecting center points of the third beam combination mirror 24 and the second beam combination mirror 22 is parallel to the light emitting direction of the first LED source 11 and perpendicular to the light emitting direction of the laser source L. Both the laser source L and the first LED source 11 direct their beams toward the center of the third beam combination mirror 24, making the laser spot on the third beam combination mirror 24 and the light spot from the first LED source 11 symmetrical about the center of the third beam combination mirror 24. The laser spot is positioned at the center of the light spot of the combined beam, ensuring a more uniform energy distribution in the light spot of the combined beam.

Because the laser beam has higher energy than the beam emitted from the LED, the energy of beam of the fourth wavelength band emitted from the first LED source 11 and reflected by the third beam combination mirror 24 is very small compared to the laser beam, which will not cause a large light loss.

FIG. 16 is fourteenth schematic structural diagram of a light source apparatus according to embodiments of the disclosure.

In some embodiments, as shown in FIG. 16, the first beam combination assembly can include one beam combination component, which can be a fourth beam combination mirror 25. The fourth beam combination mirror 25 is located between the first LED source 11 and the second beam combination mirror 22, and at the intersection of the beam emitted from the first LED source 11 and the laser beam emitted from the laser source L. The fourth beam combination mirror 25 includes a reflection region f′ and a transmission region. In some embodiments, a part of the surface of the fourth beam combination mirror 25, facing away from the first LED source 11, is coated with a reflection layer, to form the reflection region f′. The reflection region f′ is configured to reflect the laser beam emitted from the laser source L toward the second beam combination mirror 22. The other parts of the fourth beam combination mirror 25, excluding the zone with the reflection region f′, are used as the transmission region and are configured to transmit the beam emitted from the first LED source 11.

In specific implementations, the fourth beam combination mirror 25 can be a transparent plate with a reflection film coated in the reflection region. In some embodiments, the transparent plate can be, for example, a glass plate, which is not limited here.

The laser beam emitted from the laser source L is incident on the reflection region f′ and is reflected toward the second beam combination mirror 22, while the beam emitted from the first LED source 11 passes directly through the zones of the fourth beam combination mirror 25 excluding the reflection region f′ and is directed toward the second beam combination mirror 22. As such, the beam emitted from the first LED source 11 is combined with the laser beam emitted from the laser source L.

The reflection region f′ is positioned at the center of the fourth beam combination mirror 25. A line connecting center points of the fourth beam combination mirror 25 and the second beam combination mirror 22 is parallel to the light emitting direction of the first LED source 11 and perpendicular to the light emitting direction of the laser source L. The laser spot emitted from the laser source L onto the reflection region f′ is symmetrical about the center point of the reflection region f′. The light spot from the first LED source 11 onto the fourth beam combination mirror 25 is also symmetrical about the center point of the fourth beam combination mirror 25. This arrangement positions the laser spot at the center of the light spot of the combined beam, achieving a more uniform energy distribution in the light spot of the combined beam.

Since the reflection region f′ can block part of the beam emitted from the first LED source 11, the size of the reflection region f′ should be kept as small as possible, for example, an area can be less than or equal to 1/10 of an area of the light spot emitted from the first LED source 11. As such, the energy loss of the beam emitted from the first LED source 11 due to the blocking of the reflection region f′ can be controlled to within 10%. Because the laser beam has higher energy than the beam emitted from the LED, the blocked portion of the beam emitted from the first LED source 11 can be compensated by the laser beam, which will not cause a large light loss.

In specific implementations, any of the structures for the first beam combination assembly shown in FIGS. 14 to 16 can be configured to combine the beam emitted from the first LED source 11 and laser beam emitted from the laser source L. The combined beam can be then further combined with the beams emitted from the second LED source 12 and the third LED source 13 to get a white beam, which is then emitted in a set direction.

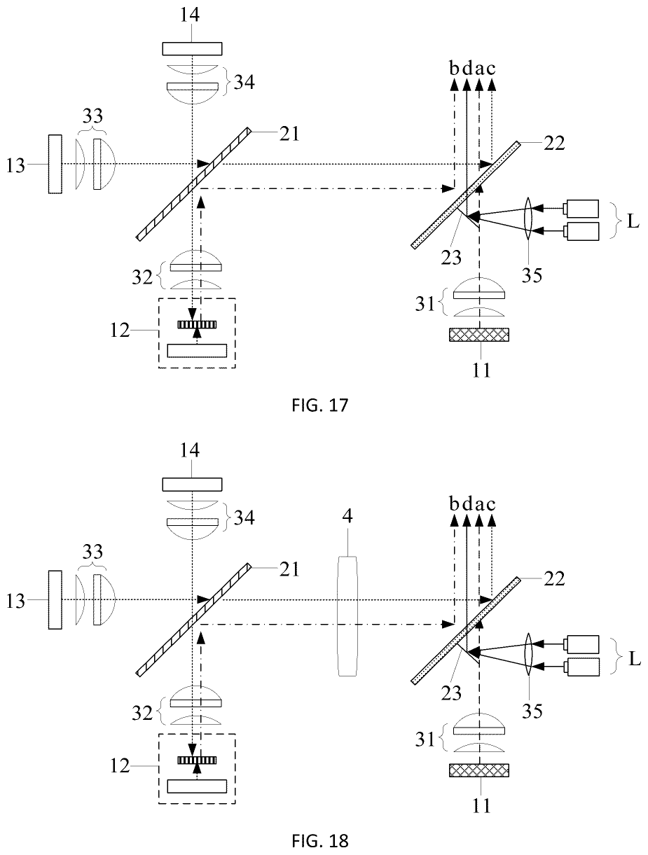

FIG. 17 is fifteenth schematic structural diagram of a light source apparatus according to embodiments of the disclosure.

As shown in FIG. 17, the light source apparatus further includes: a first collimating lens group 31, a second collimating lens group 32, a third collimating lens group 33, and a fourth collimating lens group 34. The first collimating lens group 31 is positioned at the light emitting side of the first LED source 11, the second collimating lens group 32 is positioned at the light emitting side of the second LED source 12, the third collimating lens group 33 is positioned at the light emitting side of the third LED source 13, and the fourth collimating lens group 34 is positioned at the light emitting side of the fourth LED source 14.

Since the beam emitted from the LED source follows a Lambertian distribution and has a relatively large divergence angle, each LED source is equipped with a collimating lens group at its light emitting side. This allows the beam emitted from each LED source to be collimated before further propagation.

The collimating lens group includes at least one lens. For example, in FIG. 17, the collimating lens group may include two lenses, which is not limited here. The structure of the first collimating lens group 31, the second collimating lens group 32, the third collimating lens group 33, and the fourth collimating lens group 34 can be either the same or different, which is not limited here.

FIG. 18 is a sixteenth schematic structural diagram of a light source apparatus according to embodiments of the disclosure.

As shown in FIG. 18, the light source apparatus further includes a beam-reducing lens group 4. The beam-reducing lens group 4 is located between the first beam combination mirror 21 and the second beam combination mirror 22.

Because the optical paths of the beam emitted from each LED source before beam combining are different, and the beam emitted from the LED source inherently has a certain divergence angle, the optical paths of the beams from the second LED source 12 and the third LED source 13 are longer than that of the first LED source 11, before reaching the second beam combination mirror 22. The longer the optical path, the larger the spot size after divergence. Therefore, before the combined beam of the second LED source 12 and the third LED source 13 reaches the second beam combination mirror 22, the combined beam needs to passes through the beam-reducing lens group 4, so that the light spot of the combined beam from the second LED source 12 and the third LED source 13 is as close in size as possible to the light spot of the first LED source 11.

In embodiments of the disclosure, the beam-reducing lens group 4 includes at least one lens. When only one lens is used, the lens can be a convex lens, which is not limited here.

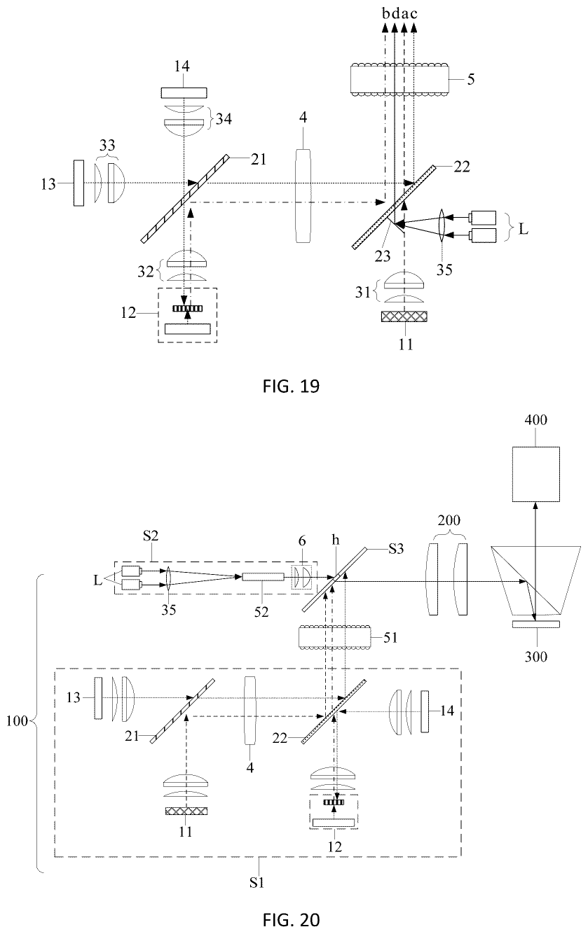

FIG. 19 is a seventeenth schematic structural diagram of a light source apparatus according to embodiments of the disclosure.

As shown in FIG. 19, the light source apparatus further includes a beam homogenization component 5. The beam homogenization component 5 is positioned at the light emitting side of the second beam combination mirror 22.

In the embodiments of the disclosure, the beam homogenization component 5 is placed at the light emitting side of the second beam combination mirror 22, which can further homogenize the combined beam from the different LED sources and the laser source. Only one beam homogenization component 5 needs to be arranged in the light source apparatus. This helps simplify the structure of the light source apparatus and reduce the size the light source apparatus.

In specific implementations, as shown in FIG. 19, the beam homogenization component 5 can be a fly-eye lens group. The fly-eye lens group includes a first fly-eye lens and a second fly-eye lens arranged opposite to each other. The surfaces of both the first fly-eye lens and the second fly-eye lens include an array of small lens units. The combined beam after the second beam combination mirror 22 typically include parallel rays, which pass through the first fly-eye lens, and then are focused on the centers of the small lens units of the second fly-eye lens. The second fly-eye lens then superposes the imaging rays from the first fly-eye lens onto an illumination surface. This effectively improves the uniformity and brightness of the illumination beam.

Further, the beam homogenization component 5 can be other elements such as a light-pipe or light rod, which is not limited here.

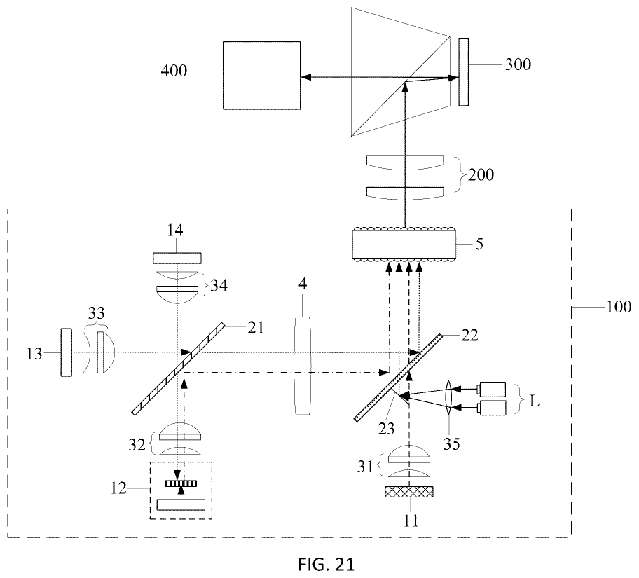

According to another aspect of the disclosure, a projection system is provided. FIG. 20 is a first schematic structural diagram of a projection system according to embodiments of the disclosure, and FIG. 21 is a second schematic structural diagram of a projection system according to embodiments of the disclosure.

As shown in FIGS. 20 and 21, the projection system includes the light source apparatus 100 described above, an illumination path component 200, a light valve modulation component 300, and a projection lens 400. The illumination path component 200 is located at a light emitting side of the light source apparatus 100. The light valve modulation component 300 is located at a light emitting side of the illumination path component 200, and the projection lens 400 is positioned in a reflection path of the light valve modulation component 300.

In some embodiments, as shown in FIG. 20, the light source apparatus 100 includes two types of light source assemblies: an LED source assembly and a laser source assembly. The brightness of the laser source assembly is greater than that of the LED source assembly. By adding a laser source assembly to the light source apparatus and combining the monochromatic beam emitted from the laser source assembly with the three-color beam emitted from the LED source assembly, the brightness of the emitted light can be increased without changing the structure of the LED source assembly. The laser source has a wide color gamut, so adding a laser source assembly to the light source apparatus and adjusting the ratio of the laser source and the LED source can effectively enhance color performance and improve the color gamut. Currently, common laser sources are smaller in size and consume less energy than their corresponding LED sources, thus combining LED source assembly with laser source assembly will not excessively increase the size and energy consumption of the light source apparatus.

In some embodiments, as shown in FIG. 21, a laser source is added to the light source apparatus. The brightness of the laser source is greater than that of the LED source. By adding a laser source to the three-color LED source system and combining the laser beam emitted from the laser source with the beam, of the same color as the laser beam, emitted from the LED source, then combining them with the beams from LED source of other colors, the brightness of the light emitted from the light source apparatus can be increased. The laser source has a wide color gamut, thus adding a laser source to the light source apparatus and adjusting the ratio of the laser source and the LED source can effectively enhance color performance and improve the color gamut. Currently, common laser sources are smaller in size and consume less energy than their corresponding LED sources, thus adding a laser source to the original LED source system will not excessively increase the size and energy consumption of the light source apparatus.

The illumination path component 200 is located at the light emitting side of the light source apparatus 100. The illumination path component 200, on the one hand, collimates the beam emitted from the light source apparatus 100, and on the other hand, allows the beam emitted from the light source apparatus 100 to enter the light valve modulation component 300 at an appropriate angle. The illumination path component 200 can include multiple lenses or lens groups, which is not limited here.

The light valve modulation component 300 is configured to modulate and reflect the incident beam. In specific implementations, the light valve modulation component 300 can be a Digital Micromirror Device (DMD). After passing through the illumination path component 200, the beam meets the illumination size and incident angle required by the DMD. The DMD surface includes tens of thousands of tiny mirrors, each of which can be individually driven to tilt. By controlling the DMD, the brightness of the light reflected into the projection lens 400 can be controlled.

The projection lens 400 is configured to image the beam emitted from the light valve modulation component 300. After imaging through the projection lens 400, the beam is used for projection imaging.

The projection system can obtain the desired image quality with enhanced color performance, color gamut, and brightness by controlling the color ratio of the laser source and the LED source.

It should be noted that, the above first/second/third/fourth beam combination mirrors are described with different orders only for clearly distinguishing different beam combination mirrors, rather than indicating the order of positions/importance. In different embodiments, based on different orders of appearance, a same one beam combination mirror can be beam combination component with different indexes.

Although the preferred embodiments of the disclosure have been described, those skilled in the art can make additional changes and modifications to these embodiments once they know the basic inventive concepts. Therefore, the appended claims are intended to be explained as including the preferred embodiments and all changes and modifications falling within the scope of the disclosure.

Obviously, those skilled in the art can make various changes and modifications to the embodiments of the disclosure without departing from the spirit and scope of the embodiments of the disclosure. Thus, if these changes and modifications of the embodiments of the disclosure fall within the scope of the claims of the disclosure and their equivalents, the disclosure is also intended to include these changes and modifications.

What is claimed is:

1. A light source apparatus,
a Light Emitting Diode (LED) source assembly, at least comprising: a first LED source, a second LED source, a third LED source and a fourth LED source; wherein
the first LED source is configured to emit a beam of a first wavelength band;
the second LED source is configured to emit a beam of a second wavelength band;
the third LED source is configured to emit a beam of a third wavelength band; and
a beam emitted from the fourth LED source is configured to be incident on a light emitting surface of the second LED source, and irradiate and excite the second LED source to emit the beam of the second wavelength band;
a laser source assembly, configured to emit a laser beam of a fourth wavelength band, wherein the first wavelength band covers the fourth wavelength band; and
a first beam combination component and a second beam combination component;
wherein
the first LED source and the laser source assembly are arranged in such a way that a light incident direction along which the beam emitted from the first LED source is incident on the second beam combination component and a light incident direction along which the laser beam is incident on the second beam combination component are perpendicular;
the second beam combination component is configured to combine the beam emitted from the first LED source and the laser beam by reflecting one of the beam emitted from the first LED source and the laser beam and transmitting the other of the beam emitted from the first LED source and the laser beam;
a light incident direction along which the beam emitted from the first LED source and the laser beam are incident on the first beam combination component and a light incident direction along which the beam emitted from the second LED source and the beam emitted from the third LED source are incident on the first beam component are perpendicular; wherein the first beam combination component is configured to reflect one of the two incident beams whose light incident directions are perpendicular and to transmit the other of the two incident beams two incident beams whose light incident directions are perpendicular.

2. The light source apparatus according to claim 1, further comprising a third beam combination component;
wherein a light incident direction along which the beam emitted from the second LED source is incident on the third beam combination and a light incident direction along which the beam emitted from the third LED source is incident on the third beam combination are perpendicular;
the third beam combination component is configured to combine the beam emitted from the second LED source and the beam emitted from the third LED source by reflecting one of the beam emitted from the second LED source and the beam emitted from the third LED source and transmitting the other of the beam emitted from the second LED source and the beam emitted from the third LED source.

3. The light source apparatus according to claim 1, wherein the beam of the first wavelength band is red light, the beam of the second wavelength band is green light, the beam of the third wavelength band is blue light, and the laser beam of the fourth wavelength band is the red light;
the first LED source is a red LED, the second LED source is a green LED, the third LED source is a blue LED, and the beam emitted from the fourth LED source has a wavelength smaller than a wavelength of the beam emitted from the second LED source; and
the laser source is a red laser.

4. The light source apparatus according to claim 1, wherein the second beam combination component is configured to reflect one of the beam of the fourth wavelength band and the beam of the first wavelength band and to transmit the other of the beam of the fourth wavelength band and the beam of the first wavelength band.

5. The light source apparatus according to claim 4, wherein the second beam combination component is a beam combination mirror, comprising a reflection region and a transmission region;
a part of a surface, facing away from the first LED source, of the beam combination mirror is provided with a reflection layer to form the reflection region, and the other part of the beam combination excluding the reflection region forms the transmission region.

6. The light source apparatus according to claim 4, wherein the second beam combination component is a dichroic mirror, and is configured to reflect the beam of the fourth wavelength band and transmit the beam of the first wavelength band excluding rays of the fourth wavelength band.

7. The light source apparatus according to claim 4, wherein a center of a light spot, on the second beam combination component, of the beam emitted from the laser source assembly and a center of a light spot, on the second beam combination component, of the beam emitted from the first LED source coincide.

8. The light source apparatus according to claim 2, wherein the second LED source and the fourth LED source are arranged in such a way that a light incident direction along which the beam emitted from the fourth LED source is incident on the light emitting surface of the second LED source is opposite to a light emitting direction of the second LED source; and
the third beam combination component is configured to reflect one of green light and blue light and transmit the other of the green light and the blue light.

9. The light source apparatus according to claim 1, further comprising a beam homogenization component at a light emitting side of the first beam combination component.

10. The light source apparatus according to claim 9, wherein the beam homogenization component is a fly-eye lens group.

11. The light source apparatus according to claim 1, wherein the laser source assembly comprises at least one laser source and a beam homogenization component at a light emitting side of the at least one laser source; and
a beam emitted from the at least one laser source is incident on the second beam combination component after passing through the beam homogenization component for beam homogenization.

12. The light source apparatus according to claim 1, further comprising:
a first collimating lens group at a light emitting side of the first LED source;
a second collimating lens group at a light emitting side of the second LED source;
a third collimating lens group at a light emitting side of the third LED source; and
a fourth collimating lens group at a light emitting side of the fourth LED source.

13. A light source apparatus, comprising:
a Light Emitting Diode (LED) source assembly, at least comprising: a first LED source, a second LED source, a third LED source and a fourth LED source; wherein
the first LED source is configured to emit a beam of a first wavelength band;
the second LED source is configured to emit a beam of a second wavelength band;
the third LED source is configured to emit a beam of a third wavelength band; and
a beam emitted from the fourth LED source is configured to be incident on a light emitting surface of the second LED source, and irradiate and excite the second LED source to emit the beam of the second wavelength band;
a laser source assembly, configured to emit a laser beam of a fourth wavelength band, wherein the first wavelength band covers the fourth wavelength band;
a first beam combination component, a second beam combination component and a third beam combination component; wherein
the third beam combination component is configured to obtain a first combined beam, by reflecting one of the beam emitted from the first LED source and the beam emitted from the third LED source and transmitting the other of the beam emitted from the first LED source and the beam emitted from the third LED source, toward the first beam combination component along a first direction;
the beam emitted from the second LED source is incident on the first beam combination component along a second direction;
the first beam combination component is configured to obtain a second combined beam with a light emitting direction along the second direction by reflecting one of the beam emitted from the second LED source and the first combined beam and transmitting the other of the beam emitted from the second LED source and the first combined beam; and
the second beam combination component is configured to reflect one of the second combined beam and the laser beam and transmit the other of the second combined beam and the laser beam.

14. The light source apparatus according to claim 13, wherein the second beam combination component comprises a reflection portion and a transmission portion; and
the transmission is a through-hole, and a portion of the second beam combination component excluding the through-hole is the reflection portion.

15. A light source apparatus, comprising:
a Light Emitting Diode (LED) source assembly, at least comprising: a first LED source, a second LED source, a third LED source and a fourth LED source; wherein
the first LED source is configured to emit a beam of a first wavelength band;
the second LED source is configured to emit a beam of a second wavelength band;
the third LED source is configured to emit a beam of a third wavelength band; and
a beam emitted from the fourth LED source is configured to be incident on a light emitting surface of the second LED source, and irradiate and excite the second LED source to emit the beam of the second wavelength band;
a laser source assembly, configured to emit a laser beam of a fourth wavelength band, wherein the first wavelength band covers the fourth wavelength band;
a first beam combination component and a second beam combination component; wherein
the second beam combination component is configured to obtain a combined beam, by reflecting one of the beam emitted from the second LED source and the beam emitted from the third LED source and transmitting the other of the beam emitted from the second LED source and the beam emitted from the third LED source, toward the first beam combination component along a first direction;
the laser beam emitted from the laser source assembly is reflected toward the first beam combination component along a second direction, wherein the second direction is a light emitting direction of the first LED source; and
the first beam combination component is configured to reflect one part of the combined beam, the beam emitted from the first LED source and the laser beam and transmit the other part of the combined beam, the beam emitted from the first LED source and the laser beam.

16. The light source apparatus according to claim 15, wherein the beam of the first wavelength band is red light, the beam of the second wavelength band is green light, the beam of the third wavelength band is blue light, and the laser beam of the fourth wavelength band is the red light;
the first LED source is a red LED, the second LED source is a green LED, and the third LED source is a blue LED, and the beam emitted from the fourth LED source has a wavelength smaller than a wavelength of the beam emitted from the second LED source; and
the laser source is a red laser.

17. The light source apparatus according to claim 15, wherein the second LED source and the fourth LED source are arranged in such a way that a light incident direction along which the beam emitted from the fourth LED source is incident on the light emitting surface of the second LED source is opposite to a light emitting direction of the second LED source, and a light incident direction along which the beam emitted from the second LED source is incident on the second beam combination and a light incident direction along which the beam emitted from the third LED source is incident on the second beam combination are perpendicular;
the third beam combination component is configured to reflect one of the green light and the blue light and transmit the other of the green light and the blue light.

18. A projection system, comprising:
the light source apparatus according to claim 1;
an illumination path component;
a light valve modulation component; and
a projection lens;
wherein
the illumination path component is located at a light emitting side of the light source apparatus;
the light valve modulation component is located at a light emitting side of the illumination path component, and is configured to modulate and then reflect an incident beam;
the projection lens is located on a reflection path of the light valve modulation component and is configured to image a beam emitted from the light valve modulation component.

19. A projection system, comprising:
the light source apparatus according to claim 13;
an illumination path component;
a light valve modulation component; and
a projection lens;
wherein
the illumination path component is located at a light emitting side of the light source apparatus;
the light valve modulation component is located at a light emitting side of the illumination path component, and is configured to modulate and then reflect an incident beam;
the projection lens is located on a reflection path of the light valve modulation component and is configured to image a beam emitted from the light valve modulation component.

20. A projection system, comprising:
the light source apparatus according to claim 15;
an illumination path component;
a light valve modulation component; and
a projection lens;
wherein
the illumination path component is located at a light emitting side of the light source apparatus;
the light valve modulation component is located at a light emitting side of the illumination path component, and is configured to modulate and then reflect an incident beam;
the projection lens is located on a reflection path of the light valve modulation component and is configured to image a beam emitted from the light valve modulation component.
